(19) United States
(12) Patent Application Publication
(10) Pub. No.: US 2005/0088143 A1
(43) Pub. Date: Apr. 28, 2005

(54) Method and device for compensating battery voltage of mobile electronic device

(75) Inventors: Tung-Feng Yang, Taipei (TW); Ben-Chuan Du, HsinTien City (TW)

Correspondence Address: Ladas & Parry, 26 West 61st Street, New York, NY, 10023, US

(73) Assignee: BENQ CORPORATION

(21) Appl. No.: 10/967,732

(22) Filed: Oct. 18, 2004

(30) Foreign Application Priority Data
Oct. 24, 2003 (TW) 92129639

(51) Int. Cl. H02J 7/16

(52) U.S. Cl. 320/130

(57) ABSTRACT

A mobile electronic device includes a battery, a battery voltage indication module, a compensation database and a compensation processing module. The battery voltage indication module is for showing battery voltages. The compensation database is for storing compensating values of corresponding power consumption devices. The compensation processing module is for detecting whether the power consumption devices are turned on, for gathering corresponding compensating values of the actuated power consumption devices from the compensation database, and for defining compensation results in accordance with the battery voltage and the compensating values then transmits to the battery voltage indication so as to stabilize the battery voltage indication.

### BACKGROUND OF THE INVENTION

(1) Field of the Invention

The invention relates to a mobile electronic device, and more particularly to a compensation device and a method for indicating battery voltage of a mobile electronic device.

(2) Description of the Prior Art

Batteries who give electricity to mobile devices play an important role for any mobile electronic device, such as mobile phones, note books, PDAs, walkmans, etc. In this industry, the trend of designing mobile devices is to make them smaller without sacrificing powerful capability. In one effort, the designers try their best to reduce power consumption of mobile devices. On the other hand, they are devoted to extending the electricity storage of batteries. Besides, some consideration of the designers go to shrink the size and reduce the weight of the batteries.

No matter how large the electric capacity of a battery is, there is always a time that the electricity of batteries will be run out. Hence, the topic of showing exact remnant electricity of the battery becomes more important for a user to understand how much electricity of his/her battery is left. Referring to FIG. 1, by taking a typical mobile phone for example, a system block diagram of battery voltage indication according to a prior art is shown. The battery voltage indication system includes an A/D converter 10, a battery 12, a plurality of power consumption devices 14 and a battery voltage indication module 16. The battery voltage indication module 16 is to show how much electricity is still left in the battery 12 by obtaining real time voltage message from the battery 12 through the A/D converter 10, and the battery voltage indication module 16 is then to exhibit the measured a voltage/voltages by a segment indication or a percentage on a panel of the mobile phone.

Meanwhile, while an additional power consumption device 14 (e.g. a vibrator 141 or a signal processing module 144) is engaged with the battery 12, a sudden voltage drop would be shown in the battery voltage indication module 16 before the reading of the voltage of battery 12 can be recovered to a stable condition.

Influences of the forgoing phenomenon can be in two folds. One is that the unstable condition may disturb the user of the mobile phone, and another is that the mis-reading at that critic moment will lead to an inevitable mis-interpretation in a device that takes the battery voltage indication module 16 as a reference module. In a dark side, the aforesaid mis-interpretation may immediately trigger an interior voltage protection mechanism to shut down the whole system for meeting a lower voltage level. Also, the foregoing unstable condition in battery voltage indication may drive the buyers away and thus reduce directly the market share of the mobile phone applying the battery voltage indication module 16 described above. Therefore, it is the concern of the present invention to provide a compensation mechanism of the battery voltage indication for mobile electronic devices and by which that the battery voltage can no more vary in a violent way and can obtain a stable battery voltage indication.

### SUMMARY OF THE INVENTION

Accordingly, it is one object of the present invention to provide a compensating device for a battery voltage indication of a mobile electronic device.

It is another object of the present invention to provide a method for forming compensation database of a mobile electronic device.

It is one more object of the present invention to provide a compensation method for a battery voltage indication of a mobile electronic device.

In one aspect of the present invention, a preferred mobile electronic device at least includes a battery, a battery voltage indication module, a compensation database, and a compensation processing module. The battery voltage indication module is responsible to show the battery voltage. The compensation database is for storing compensating values of corresponding power consumption devices. The compensation processing module is for detecting whether the power consumption devices are turned on or not, for gathering corresponding compensating values of the actuated power consumption devices from the compensation database, and also for defining compensation results in accordance with the battery voltage and the compensating values. While any power consumption device is being actuated, the compensation processing module would transmit corresponding compensation results to the battery voltage indication module so as to stabilize the battery voltage indication.

In another aspect of the present invention, a compensation device for battery voltage indication within a mobile electronic device and a method for forming a compensation database are introduced. The method may comprise the following steps. Firstly is to gather the voltage drops corresponding to various turning-on of a plurality of power consumption devices. Next is to define compensating values with respect to each of the actuated power consumption devices individually. Finally is to store the compensating values into the compensation database.

In a further aspect of the present invention, a compensation method for a battery voltage indication within a mobile electronic device is aimed at storing compensating values into a compensation database for proceeding compensation. The method comprises the following steps. Firstly is to measure the battery voltage. Next is to detect whether a plurality of power consumption devices are turned on or not. Then is to gather corresponding compensating values of the actuated power consumption devices from the compensation database. Finally is to obtain compensation results with respect to the battery voltage and the compensating values.

### BRIEF DESCRIPTION OF THE DRAWINGS

The present invention will now be specified with reference to its preferred embodiment illustrated in the drawings, in which

FIG. 1 is a block diagram of a conventional battery voltage indication system for mobile phones;

FIG. 2 is a block diagram of a preferred battery voltage indication system for mobile phones in accordance with the present invention;

FIG. 3 is a flow chart of compensating steps according to one embodiment of the present invention;

FIG. 4 is a flow chart of a method for forming compensation database according to one embodiment of the present invention;

FIG. 5 is a table of a compensation database according to one embodiment of the present invention; and

FIG. 6 is a table of compensation database relating to different power levels and whether the mobile phone is at an on-transmission or a no-transmission in accordance with one embodiment of the present invention.

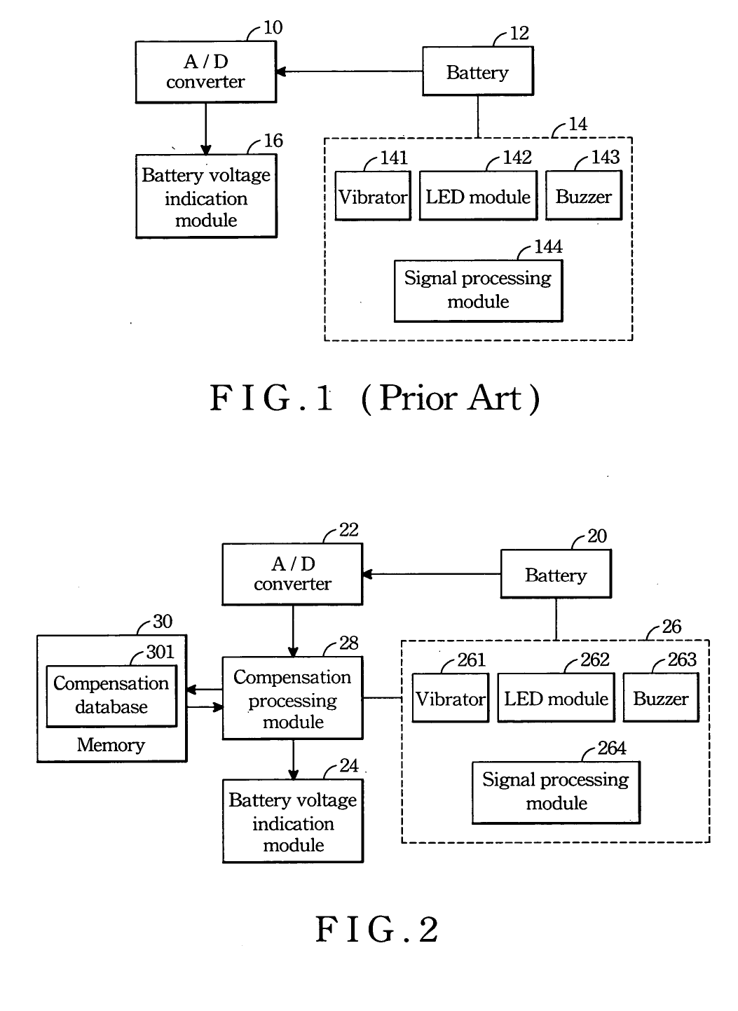

### DESCRIPTION OF THE PREFERRED EMBODIMENT

The invention disclosed herein is to provide a compensation device and a method for a battery indication of a mobile electronic device. In the present invention, as one or more of power consumption devices are actuated to draw a large amount of current so as to induce a huge voltage drop from the battery, the mobile electronic device can compensate the battery voltage indication by using compensating values already stored in the compensation database so as to maintain a stable battery voltage indication. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

FIG. 2 shows a block diagram of a preferred battery voltage indication system for mobile electronic devices in accordance with the present invention. In the present embodiment, a mobile phone system as a typical example includes a battery 20, an A/D converter 22, a battery voltage indication module 24, a plurality of power consumption devices 26, a compensation processing module 28, and a memory 30. The battery 20 can provide electricity to the mobile phone. The A/D converter 22 can measure the voltage of the battery 20 and transform the voltage signal from an analog form to a digital form so as to show the voltage signal on the panel of the mobile phone through the battery voltage indication module 24.

The battery voltage indication module 24 can transform the digital voltage signal to a segment indication or a percentage form for showing on the panel of the mobile phone in order to tell users how much remnant electricity is left in the battery 20. It should be noted, by means of the program codes stored in the interior or exterior memory of the battery voltage indication module 24, that the battery voltage indication module 24 can perform voltage indication transformation. The power consumption devices 26 can generally include any power-consuming device such as a vibrator 261, an LED module 262, a buzzer 263, and a signal processing module 264, etc. Any further modification of other power consumption devices is well known to the skilled person in the art and definitely any intent to include such a modification shall be within the scope of this invention.

The compensation processing module 28 can deal with the compensating procedure for battery voltage indication. By means of the program codes stored in the interior or exterior memory of the compensation processing module 28, the compensation processing module 28 can perform detecting, gathering, and compensating function as well. The memory 30 can store a compensation database 301 in advance. The compensation database 301 can store different compensating values (also known as voltage values) with respect to the corresponding power consumption devices. While the compensation processing module 28 detects some of the power consumption devices 26 are actuated, the compensation processing module 28 will gather each of the corresponding compensating values from the compensation database 301. For the voltage values of the battery 20 is measured from the A/D converter 22, the foregoing compensating values can be easily obtained. Finally, the compensation processing module 28 can transmit the compensation results to the battery voltage indication module 24 for showing on the panel of the mobile phone. As a result, the voltage indication of the mobile phone can remain in a stable state.

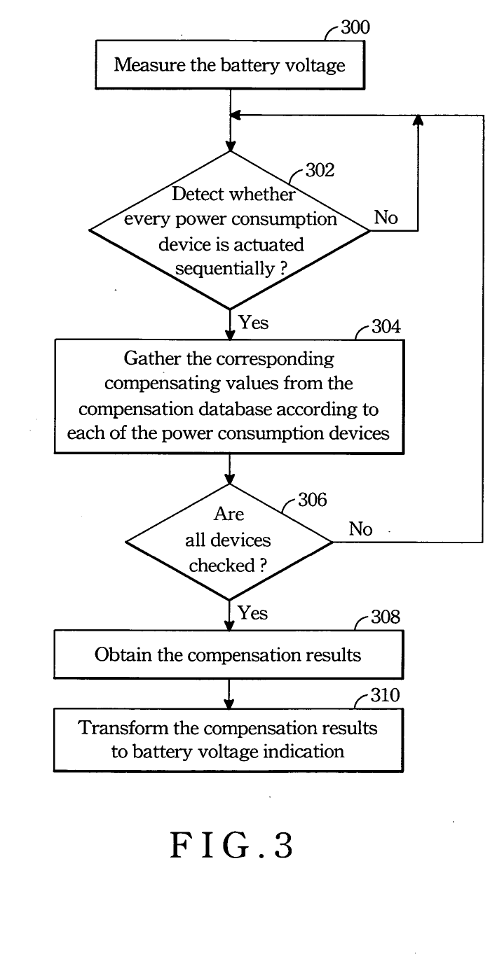

FIG. 3 illustrates a flow chart of preferred compensating steps in accordance with one embodiment of the present invention. Firstly, the A/D converter 22 measures the voltage of the battery 20 (step 300). Next, the compensation processing module 28 detects whether pr not every power consumption device 26 is actuated sequentially (step 302). If there is no power consumption device 26 actuated, the compensation process is needless. If any power consumption device 26 is turned on, the compensation processing module 28 will gather the compensating values for corresponding power consumption devices 26 from the compensation database 301 (step 304). Then, the compensation processing module 28 conforms whether all power consumption devices 26 are checked (step 306). Next, the compensation processing module 28 determines compensation results according to the voltage of the battery 20 and the compensating values (step 308). Here, the compensation of battery voltage indication is taken as an example. Hence. the compensation processing module 28 transmits the compensation results to the battery voltage indication module 24 which can then perform a transformation to obtain a stable voltage indication (step 310). Additionally, the compensation results can also be used for the voltage protection mechanism of the mobile electronic device to obtain battery voltage precisely.

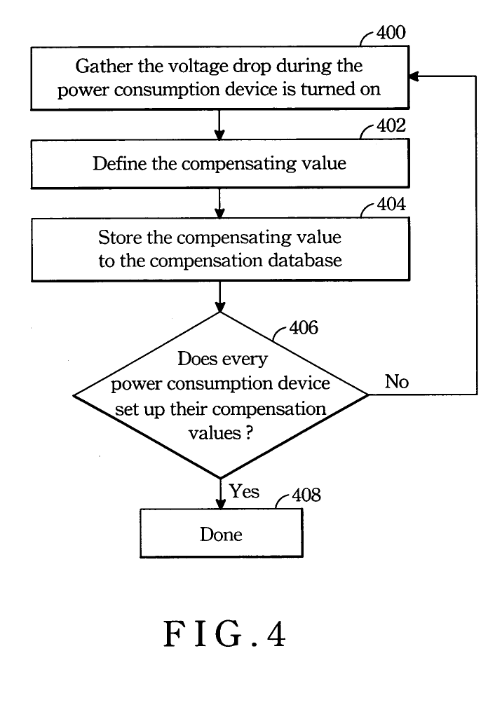

In addition, the method for making the compensation database in accordance with the present invention is shown in FIG.4. Firstly, the compensation processing module 28 can gather the voltage drop during any power consumption device 26 is turned on (step 400). Next, the compensating value can be defined, based on the voltage drop (step 402). Then, the compensating value corresponding to the power consumption device can be stored in the compensation database 301 (step 404). Finally, the compensation processing module 28 may confirm whether all power consumption devices are checked to have their own compensating values. If any power consumption device does not have its compensating value, go back to step 400 to resume the process again until all the compensating values are established.

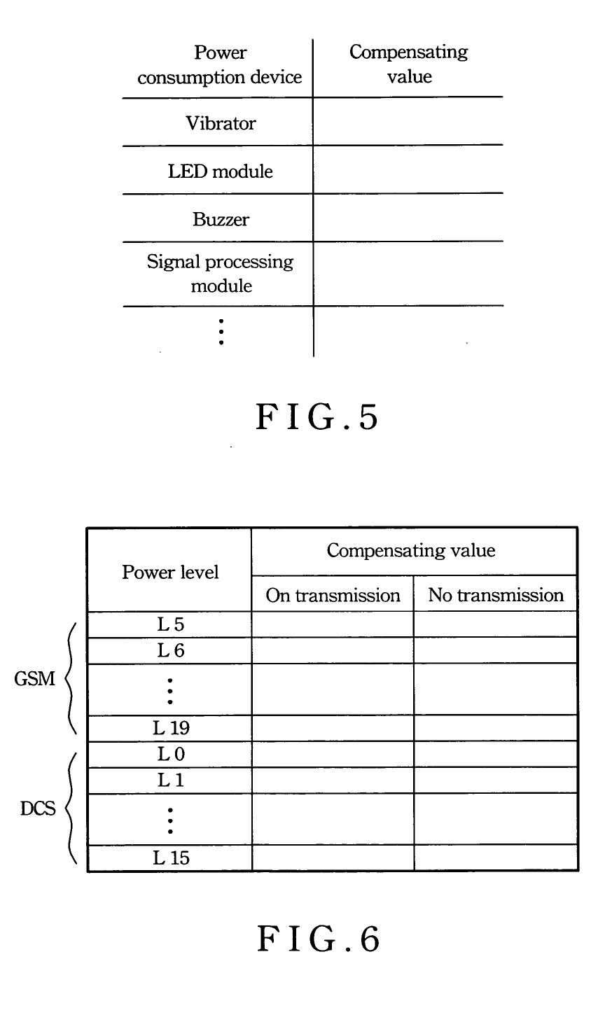

FIG. 5 shows a table of compensation database according to one embodiment of the present invention. As shown, different power consumption devices have corresponding compensating values. It should be noted that the present embodiment adopts a mobile phone as a typical example. Hence, as shown in FIG. 6, while in constructing the compensation database, different power levels should stand for corresponding compensating values (e.g. L5 to L19 for GSM system and LO to L15 for DCS system). Furthermore, different status (on-transmission or no-transmission) of the mobile phone have different compensating values, even though the mobile phone is at the same power level. This is because different status lead to different power consumption. Therefore, in order to stabilize battery voltage indication, different compensating values are needed.

In summary, the present invention provides at least the following advantages over the conventional techniques:
(1) By means of forming the compensation database even though the power consumption devices are actuated, the battery voltage indication of the mobile electronic device may remain in the stable state.
(2) For the devices who took the battery voltage as a reference, through the compensation mechanism of the present invention, the battery voltage may remain in a stable state so as to avoid occurring of error functions.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

1. A battery voltage compensation method for a mobile electronic device by using compensating values stored in a compensation database to compensate a battery voltage indication, comprising steps of:
measuring a battery voltage;
detecting whether a plurality of power consumption devices turning on;
gathering said corresponding compensating values of the power consumption devices being turned on from said compensation database; and
determining a compensation result in accordance with said battery voltage and said compensating values.

2. The method of claim 1, further comprising a step of transforming said compensation result to get said battery voltage indication.

3. The method of claim 1, wherein said compensation database is stored in a memory.

4. The method of claim 1, wherein said compensating value is a voltage.

5. The method of claim 1, wherein said mobile electronic device is a mobile phone.

6. The method of claim 5, wherein one of said power consumption devices is a signal processing module.

7. A method for forming a compensation database and for compensating a battery voltage indication of a mobile electronic device, comprising steps of:
gathering voltage drops of a plurality of power consumption devices when said power consumption devices turning on respectively;
defining compensating values according to each of said power consumption devices being turned on individually; and
storing said compensating values to said compensation database.

8. The method of claim 7, wherein said compensating values are voltages.

9. The method of claim 7, wherein said compensation database is stored in a memory.

10. The method of claim 7, wherein said mobile electronic devices are mobile phones.

11. The method of claim 10, wherein one of said power consumption devices is a signal processing module.

12. A mobile electronic device, comprising:
a battery for providing said mobile electronic device electricity;
a battery voltage indication module for showing voltage value of said battery;
a compensation database for storing compensating values of corresponding power consumption devices, wherein said compensating values are defined by voltage drops during said power consumption devices turning on individually; and
a compensation processing module for detecting whether the power consumption devices turning on and for gathering said corresponding compensating values of said power consumption devices turning on from said compensation database and for obtaining compensation results in accordance with said battery voltage and said compensating values;
wherein, while any said power consumption device is actuated, said compensation processing module transmits corresponding compensation results to said battery voltage indication module so as to stabilize said battery voltage indication.

13. The mobile electronic device of claim 12, further comprising an A/D converter for measuring said voltage of said battery.

14. The mobile electronic device of claim 12, wherein said battery voltage indication module is for transforming said compensation result to get said battery voltage indication.

15. The mobile electronic device of claim 12, wherein said compensating values are voltages.

16. The mobile electronic device of claim 12, wherein said compensation database is stored in a memory.

17. The mobile electronic device of claim 12, wherein said mobile electronic device is a mobile phone.

18. The mobile electronic device of claim 17, wherein one of said power consumption devices is a signal processing module.
